(19) United States
(12) Patent Application Publication
(10) Pub. No.: US 2023/0129332 A1
(43) Pub. Date: Apr. 27, 2023

(54) HIGH-EFFICIENCY MICROBIOLOGICAL LIQUID PURIFICATION SYSTEM AND METHODS OF USE

(71) Applicants: Omar Michael ABNEY, Marietta, GA (US); Sarah Elizabeth ABNEY, Marietta, GA (US)

(72) Inventors: Omar Michael ABNEY, Marietta, GA (US); Sarah Elizabeth ABNEY, Marietta, GA (US)

(21) Appl. No.: 18/049,735

(22) Filed: Oct. 26, 2022

Related U.S. Application Data
(60) Provisional application No. 63/271,758, filed on Oct. 26, 2021.

(51) Int. Cl. C02F 1/02

(52) U.S. Cl. CPC C02F 1/02; C02F 2103/002

(57) ABSTRACT

A system and method for the microbiological purification of a liquid. The system includes a high-efficiency plate heat exchanger connected to a coil recirculation chamber via a high-efficiency infrared electric liquid-heater. The liquid enters the system at an ambient temperature, the temperature is raised by the heater and maintained in the chamber via recirculation by a pump. An electronic controller redirects the liquid through the exchanger to cool it and supply to a plumbed outlet. In combination, the system can be used to monitor and control various temperatures, pressures, flow rates, and heat exchanges in order to purify the liquid. The method includes steps to produce, install, implement, and use the liquid purification system to eliminate, neutralize, kill, or otherwise exclude/minimize biological organisms and contamination from the liquid.

### CROSS-REFERENCE TO RELATED APPLICATIONS

To the full extent permitted by law, the present United States Non-Provisional Patent Application hereby claims priority to and the full benefit of, United States Provisional Application entitled “MICROBIOLOGICAL WATER PURIFIER (MWP),” having assigned Ser. No. 63/271,758, filed on Oct. 26, 2021, which is incorporated herein by reference in its entirety.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE DISCLOSURE

### Technical Field of the Disclosure

The present invention relates to a liquid heating and recirculation system, referred to herein as a microbiological liquid purification system. More particularly, the present invention relates to a water temperature regulation and (re)circulation system for a residential and/or commercial water treatment and safety system, as well as other applications.

### Description of the Related Art

Concern over drinking water purity, safety, and taste have prompted alternative sources of supply other than that which may be supplied by residential taps, wells, tanks, springs, municipal supplies, other groundwater/rainwater supplies, and/or processed water thereof. This concern has arisen both in the developed and the developing world due to factors such as water pollution, air pollution (which may cause acid rain), inaccessibility of clean water sources due to remoteness, and/or by tap water often containing large amounts of water treatment chemicals, minerals, microorganisms, and other matter.

One attempt to deal with this problem, namely in the developed world, is the increased use of bottled waters. Sales of bottled waters in the developed world have increased substantially in recent decades. Bottled water packaging and volume may consist of single serving (e.g., 12 oz. bottles) to larger vessels such as gallon or 5-gallon containers, which may offer a high quantity of servings and may feature the ability to combine with a water dispenser (e.g., a hot and cold water dispenser). Bottled cool water dispensers are popular for both residential and commercial use because cold drinking water may be dispensed from generally large bottles without the need for plumbing and infrequent replacement. Their popularity in the developed world, especially in offices, has even become well known and recognized fixture of conversation. However, such bottled waters are expensive, require a logistical operation or exchange process, and changing and/or storing large heavy and cumbersome bottles is burdensome. Additionally, in the developing world, possibly only the relatively very wealthy may be able afford reliable access to clean drinking water using such a complicated logistical system.

Several issues with the safety of bottled waters also have been theorized, identified and/or uncovered in recent decades. Bottled waters, or their dispensers, can readily become contaminated by airborne bacteria and viruses, and the deposit thereof, during the dispensing operation by the introduction of ambient air drawn inside the bottle as the water is dispensed or infections may spread through the use of shared water sources, such as in an office or restaurant. Further, the storing stagnant bottled water may allow bacteria, fungus, or mold to grow unchecked. Additionally, some alarming research regarding the extended contact between water and plastics have left many concerned regarding the safety of drinking water which has been stored for extended periods in various types of plastics (e.g., BPA- and PET-containing plastics may introduce estrogen-like compounds into water stored therein). This has led many to conclude, believe, or at least fear that bottled water may be no purer, or sometimes even less pure, than ordinary tap water. Such problems with tap and bottled water have revealed a need and desire for water treatment, or additional water treatment, at or proximate the point of dispensing it.

Many dispenser-proximate treatment alternatives may exist as they may relate to tap, well, and bottled water throughout the world, many are well known in the art, and various localities may have one or many options to treat water at, near, or proximate the point of dispensing the water. These may include filtration (e.g., carbon filtration), distillation, reverse osmosis, softening machines, sterilizing/chemical additives, the like and/or combinations thereof. While each of these systems and methods may offer various benefits to users, such as ease of use, safety, convenience, effectiveness, portability, relative inexpensiveness, reliability, energy efficiency, and other benefits, many also come with the opposite as a tradeoff (e.g., difficulty of use, inconvenience, expense, etc.). By way of example, reverse osmosis may have a tendency to become clogged by high levels of hardness minerals and thus may not be feasible for some geographic locations. Other problems with reverse osmosis include the waste of large volumes of the source water, expensiveness of various membranes which may require replacement, and the requirement that feed lines be pressurized. Similarly, filtration, distillation, chemical treatment, and softening systems may be similarly geographically or water-source ineffective, inefficient, impractical, etc.

Yet other systems may rely on heating and/or irradiation treatment (e.g., UV, IR) to expose the liquid(s) and their dissolved solutes (or other suspended or emulsified impurities) with suitable levels of heat or radiation such that living microorganisms may be neutralized and/or killed. It is well known in the art that heating to specific temperatures for specific periods of time and/or irradiation can kill or otherwise neutralize biological microorganisms present in any liquid. Often, these technologies may be combined such that filtration removes many suspended impurities and germicidal radiation (and/or heat) neutralizes harmful microorganisms that escape filtration of the suspended solids subsequent to heat or irradiation treatment.

In many such water systems, such as a residential home, it can also be desirable generate and/or maintain a heated water source, such that at various locations throughout the installation of the water system, heated water may be obtained on-demand at an outlet. For example, baths, sinks, and the like may offer a single faucet having a dial handle and/or two handles, which may allow the control of temperature while the bath and/or sink basin fills. In such systems where heat is maintained at levels significant enough to eliminate microorganisms, a hot water source may be safer for human consumption than that of the cold-water source. However, persistently heating a vessel of water for on-demand heated water sources offers various tradeoffs. One such tradeoff is that, generally, the entire volume of a water reservoir might need to be heated to this elevated temperature before any portion of heated water should be discharged for use. By elevating and maintaining the temperature of a large volume of water, these systems are often determined to be energy-inefficient on a per-volume basis, particularly during times of decreased water demand. Lowering the volume in such vessels may increase the per-volume efficiency, but comes with the tradeoff that sufficient heated water may not be available during higher-demand hours. Additionally, most people may not prefer to drink their water at high or even warm temperatures, except potentially when making traditionally hot or warm beverages, such as coffee, tea, cocoa, etc. So, while heating and/or irradiating a water source may often offer the additional benefit of providing a water source without living microorganisms, such a water source may be inconvenient for a drinking water source.

Accordingly, there remains a continued need for an improved system and method for treating water and other liquids using heat, but providing such water source as a cool and/or unheated water supply. In particular, there remains a continued need for an improved water temperature component that is compatible with water treatment systems, the water temperature component being efficient across a wide range of conditions while providing a ready supply of heated water for human consumption and other uses.

### SUMMARY

Briefly described, in a possibly preferred embodiment, the present disclosure overcomes the above-mentioned disadvantages and meets the recognized need for a microbiological liquid purification system by providing a system and method for the microbiological purification of a liquid on demand. The system may include a high-efficiency plate heat exchanger connected to a coil recirculation chamber via a high-efficiency infrared electric liquid-heater. The liquid may enter the system at an ambient temperature, the temperature may be raised by the heater and maintained in the chamber via recirculation by a pump to a threshold, as may be monitored by a sensor. Upon reaching the threshold, an electronic controller may then redirect the liquid from its recirculation and heating cycle, back through the exchanger to cool it and supply to a plumbed outlet, such as in a household. In combination, the system can be used to monitor and control various temperatures, pressures, flow rates, and heat exchanges in order to purify the liquid. The method may include steps to produce, install, implement, and use the liquid purification system to eliminate, neutralize, kill, or otherwise exclude/minimize biological organisms and contamination from the liquid.

More specifically, the example embodiments of the microbiological liquid purification system may further include a power source, a housing, a low-voltage transformer, valves, an electronic controller, sensors, pumps, the like and/or combinations thereof. The high-efficiency plate heat exchanger may be designed or configured to receive an ambient temperature liquid source such that during operation of the heating system as herein described, by travelling through the high-efficiency plate heat exchanger the temperature of the fluid may be initially raised by receiving heat from the water exiting the system via the exchanger. Then, liquid may travel to the heater, which may be capable of quickly raising the temperature of the liquid while it travels through a flow channel thereof the heater. Then, as fluid exits the flow chamber of the heater, it may arrive at a recirculation chamber which may comprise a single tube, coiled and confined within insulation or an insulating envelope, which may be vacuum sealed. Upon exit of the recirculation temperature, if a threshold temperature has not been achieved, as may be detected by a sensor installed thereto or proximate a recirculation pump, liquid may be initially redirected to the heater, which may iteratively increase the liquid's temperature as it recirculates. Upon detection of the threshold temperature, liquid may be then diverted via, e.g., a valve and/or pump to the heat exchanger, where it may be cooled and exit the system.

In some exemplary embodiments of the disclosure, the microbiological liquid purification system may be plumbed into a residential home where it may receive a contaminated water source which may be turbid. The water source may be processed as described herein and further the microbiological liquid purification system may be plumbed to a new or existing home plumbing. In various embodiments of the disclosure, such treatment may be sufficient to fully sterilize and/or eliminate any contamination present in the water supply. Such standards may be met, such as U.S. EPA's Guide Standard and Protocol for Testing Water Purifiers through use of an in-flow, instant on, non-filtered, high-efficient system configuration. Furthermore, in various alternate embodiments, filtering units may be installed prior to entry into the microbiological liquid purification system, within a housing in the microbiological liquid purification system, or subsequent to processing via the microbiological liquid purification system. Benefits may include providing a continuous volume per second of microbiologically free liquid, such as water, juices, milks, malt beverages, wines, distillations, pre-carbonated soft drinks, the like and/or combinations thereof. Another feature of the disclosure may be the ability to produce an unlimited and/or endless supply of water at a high GPM flow rate. The microbiological liquid purification system may be free-standing, mobile, portable, permanently installed, and/or connected to a network for computer monitoring. Various components of the microbiological liquid purification system may be electronically monitored or controlled, either within the microbiological liquid purification system, locally via a network, or distantly/remotely via the Internet. These components, which may be switched on/off, potentiated, or be caused to increase a flowrate may include heating bulbs, water heating devices, pumps, sensors, valves, solenoids, the like and/or combinations thereof. These various components may operate continuously, or may be modulated on demand, depending on water supply needs of the individual location.

These and other features of the microbiological purification system and method of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The microbiological liquid purification system and method of use will be better understood by reading the Detailed Description with reference to the accompanying drawings, which are not necessarily drawn to scale, and in which like reference numerals denote similar structure and refer to like elements throughout, and in which:

FIG. 1 is a block schematic drawing of an exemplary embodiment of the microbiological liquid purification system of the disclosure;

FIG. 2 is a perspective drawing thereof;

FIG. 3 is a cross-sectional drawing of an exemplary embodiment of the high-efficiency liquid heater of the disclosure;

FIG. 4 is a top plan drawing of an exemplary embodiment of the brazed plate heat exchanger of the disclosure;

FIG. 5 is a transparent view drawing of an exemplary embodiment of the liquid heat chamber of the disclosure;

FIG. 6 is an elevation view drawing of an exemplary residence featuring an exemplary embodiment of the microbiological liquid purification system of the disclosure; and

FIG. 7 is a flowchart of an exemplary method of use of the microbiological liquid purification system of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

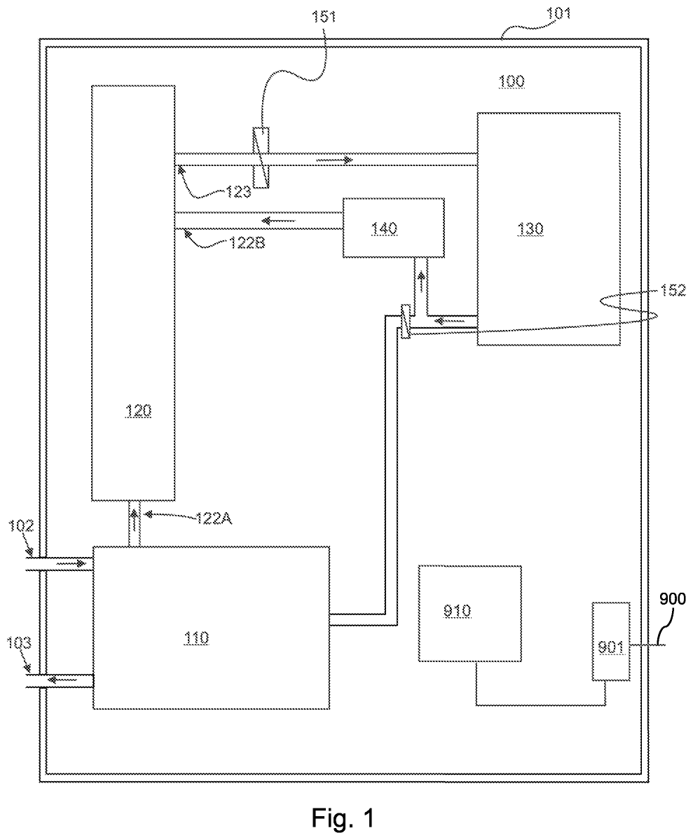

In describing the exemplary embodiments of the present disclosure, as illustrated in FIGS. 1-7, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples. It should be noted that the terms water, water source(s), liquid, and liquid source(s) may be used herein interchangeably as descriptors for any source of potable or non-potable liquid which may be utilized to supply any residence, building, or encampment with such liquid. The disclosure is not limited to any specific water or liquid source, nor any specific building, home, etc. as herein illustrated. The description is not so limited to any specific configurations or systems, except as claimed herein.

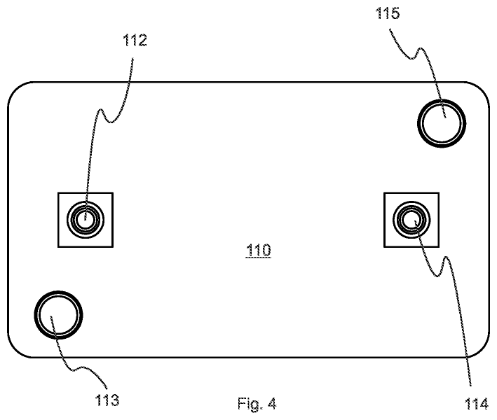

Referring now to FIG. 1 by way of example, and not limitation, therein is illustrated a block schematic drawing of an exemplary embodiment of microbiological liquid purification system 100 of the disclosure. Microbiological liquid purification system 100 may be contained within housing 101. While housing 101 is illustrated as rectangular in nature, and the parts and components as housed therein are shown in an exemplary manner, those having ordinary skill in the art may understand that any number of shapes, sizes, configurations, structures, the like and/or combinations thereof may be utilized, depending on any number of considerations, including but not limited to intended use (e.g., commercial, residential, municipal, portable, etc.), cost, the like and/or combinations thereof. Starting at where a liquid may enter microbiological liquid purification system 100, illustrated therein may be liquid source connection 102. Liquid (or water) may be supplied to liquid source connection 102 via any number of known systems and methods of supplying water, including but not limited to tank(s), municipal water supply(ies), well(s), spring(s), bucket(s), barrel(s), the like and/or combinations thereof. As may be understood by those having ordinary skill in the art, liquid may enter liquid source connection 102 in a continuous manner such that, as may be understood from a full review of the Written Description and Drawings herein, potable liquid (or water) may exit biologically pure liquid outlet 103 in a similarly continuous manner. Therefore, a pressure may exist at liquid source connection 102 and may be sustained (or vary) throughout microbiological liquid purification system 100. Upon entry into microbiological liquid purification system 100 through liquid source connection 102, various components as listed, illustrated, and described herein may receive power and may be controlled via a combination of power source 900, transformer 901, and electronic controller 910 as may be understood by those having ordinary skill in the art. For instance, high-efficiency liquid heater 120 may receive direct power from power source 900, electronic controller 910 may receive power at a reduced voltage via transformer 901, and other components (e.g., valve 151) may be both controlled by electronic controller 910 and powered by transformer 901. In other words, any system, structure, apparatus, or component requiring electrification and/or control may be connected through systems, wiring, methods, etc. as is understood by those having ordinary skill in the art. Upon entry into microbiological liquid purification system 100 through liquid source connection 102, liquid may then travel into brazed plate heat exchanger 110, which may be a standard plate exchanger commonly used to exchange heat between a heated water source and room-temperature water source, or it may be custom designed to allow entry of liquid into brazed plate heat exchanger 110 from a pressurized source at an ambient temperature, through a series of plates (e.g., metal plates), and exit through one or more openings. brazed plate heat exchanger 110 may be sealed such that liquids do not escape, and pressure remains. A second entry may be supplied with a heated water source, as will be understood by those having ordinary skill in the art upon further review of FIG. 1, and may also pass over the same plates, but the seals within brazed plate heat exchanger 110 may not allow the exchange of liquid, only heat, therebetween the plates. Hence, the ambient-temperature liquid entering brazed plate heat exchanger 110 may exit brazed plate heat exchanger 110 at a heated temperature and the heated liquid entering brazed plate heat exchanger 110 may be cooled to (approximately) ambient temperature as it exits brazed plate heat exchanger 110 and eventually microbiological liquid purification system 100 via biologically pure liquid outlet 103. Hence, upon exit of brazed plate heat exchanger 110 through the remaining components of microbiological liquid purification system 100, liquids may be further heated and treated such that they may be at an elevated temperature as they return to brazed plate heat exchanger 110 and exit microbiological liquid purification system 100, as discussed below. In a potentially preferable embodiment of microbiological liquid purification system 100, liquid may enter and exit brazed plate heat exchanger 110 (and microbiological liquid purification system 100) at 55° F. From brazed plate heat exchanger 110 into the systems and components of microbiological liquid purification system 100, liquid may enter and exit brazed plate heat exchanger 110 at higher temperatures, thus requiring less heat to be applied to the liquid flowing therein during the heat treatment process as herein described. Other features and aspects of brazed plate heat exchanger 110 may be further illustrated and described as they may relate to FIG. 4 below.

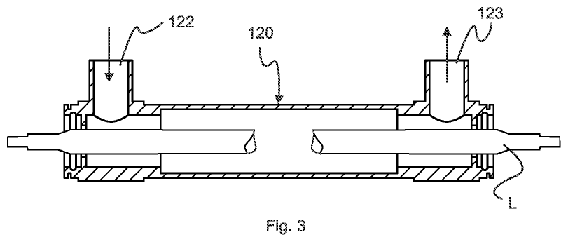

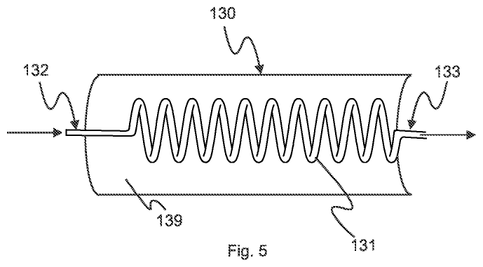

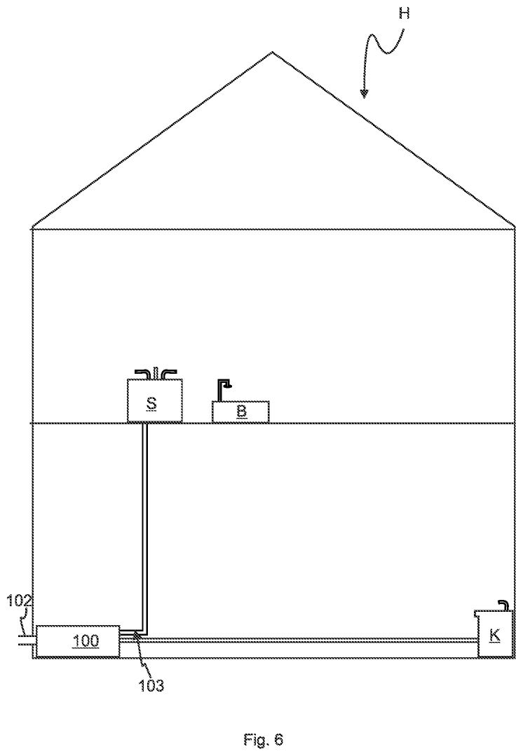

Upon exit from brazed plate heat exchanger 110, liquid may enter high-efficiency liquid heater 120 via pre-irradiation supply 122A. Though described in more detail with respect to FIG. 3 below, high-efficiency liquid heater 120 may be understood as the only and/or primary heat source of microbiological liquid purification system 100. Thus, it may require power supplied directly from power source 900 at relatively high voltages in comparison to those provided by transformer 901. However, high-efficiency liquid heater 120 may be further controlled by electronic controller 910 or may be controlled by a switch which may interrupt power from power source 900. Turning to the features of high-efficiency liquid heater 120, it may be capable of raising a temperature of a liquid passing therethrough from ambient temperatures to those up to, including and surpassing 100° C. at a rate of 0 to 6 gallons per minute (GPM) and thereby providing instant sterilization on demand at reasonably high rates to supply, for example, a residential home. As it receives elevated temperature water from brazed plate heat exchanger 110 through use of heat exchange after a period of use, power draw may be decreased and/or controlled by a combination of power source 900, transformer 901, electronic controller 910, the like and/or combinations thereof, and may further feature a thermometer/thermostat to modulate such power. Though many potential high-efficiency water/liquid heating technologies may be employed for high-efficiency liquid heater 120, in a potentially preferred embodiment of the disclosure, high-efficiency liquid heater 120 may be a high-efficiency infrared electric liquid-heater, as may be described in U.S. Pat. No. 5,371,830 entitled “HIGH-EFFICIENCY INFRARED ELECTRIC LIQUID-HEATER”, which is fully incorporated herein and described in further detail herein as it may relate to FIG. 3. Essentially, high-efficiency liquid heater 120, in this potentially preferred embodiment, may advantageously provide a high-efficiency, instant-on, in-line heater in which a silica composition allows for a heater organization in which the liquid to be heated can be reliably and safely provided in direct contact with the surface of an envelope that surrounds the filament using only infrared light exposed to the liquid that flows therethrough. Liquid may then exit high-efficiency liquid heater 120 through post-irradiation outlet 123, and such an exit flow rate may be controlled by valve 151, electronic controller 910, the like and/or combinations thereof. Upon exit of liquid from high-efficiency liquid heater 120, the liquid may then proceed to flow into liquid heat control chamber 130. liquid heat control chamber 130 may be a critical component of microbiological liquid purification system 100 that may enable the sustained and controlled high-temperature of the liquid contained and/or flowing therein, which may be necessary to meet or even exceed United States (U.S.) Environmental Protection Agency (EPA) standards for Microbiological Water Purifiers as described in its GUIDE STANDARD AND PROTOCOL FOR TESTING MICROBIOLOGICAL WATER PURIFIERS. While described in further detail in relation to FIG. 5, it may consist of, in a potentially preferred embodiment, a continuous tube having an inside diameter (ID) of between 0.5 inches and 2.0 inches and a length of between 100 feet and 400 feet, which is arranged in a coil arrangement having a coil radius from 6 inches to 48 inches, and with a number of coil turns from 10 to 200 turns. The coil of liquid heat control chamber 130 may be incased in an insulating material. An incoming liquid may enter the coil at or approximate 100° C., as described above, as having been irradiated and/or heated by high-efficiency liquid heater 120. Depending on an overall flow rate of or flow rate within microbiological liquid purification system 100, liquid may travel for a period of between 3 minutes to an unlimited number of minutes (i.e., be stored or contained) within liquid heat control chamber 130. A flow rate may be controlled by one or many of electronic controller 910, valve 151, valve 152, closed loop liquid heat maintenance pump 140, the like and/or combinations thereof as may be added or required by a person having ordinary skill in the art implementing or building microbiological liquid purification system 100 of the disclosure. In a potentially preferred embodiment of microbiological liquid purification system 100 of the disclosure, closed loop liquid heat maintenance pump 140 may be controlled by electronic controller 910 to open and/or close solenoid valves contained therein closed loop liquid heat maintenance pump 140 to activate closed loop liquid heat maintenance pump 140 and circulate liquid within/through liquid heat control chamber 130. In such a potentially preferred embodiment, sensors, thermometers, thermostats, the like and/or combinations thereof may operate in combination with these aspects to detect when fluid exiting liquid heat control chamber 130 approximates, meets, or exceeds 100° C. By way of example and not limitation, a flow meter may be provided at biologically pure liquid outlet 103, which may provide a water demand reading/data to electronic controller 910. Additionally, by way of example and not limitation, there may be installed therein microbiological liquid purification system 100 a plurality of temperature gauges, including but not limited to at/proximate high-efficiency liquid heater 120 and at/proximate liquid heat control chamber 130 to allow for continual temperature monitoring by electronic controller 910, which may cause, upon the detection of a temperature drop below liquid heat control chamber 130, for example, electronic controller 910 may open (or cause to open) a valve to cause liquid to travel through closed loop liquid heat maintenance pump 140, and initiate recirculation within microbiological liquid purification system 100. Upon such time, closed loop liquid heat maintenance pump 140 may stop pumping by, for instance, closing its solenoid valves, thereby ceasing the flow and suspending the liquid therein liquid heat control chamber 130. During such period prior to approximating, meeting and/or exceeding 100° C., the liquid may circulate from liquid heat control chamber 130 to high-efficiency liquid heater 120 via closed loop liquid heat maintenance pump 140, and then recirculate to liquid heat control chamber 130 from high-efficiency liquid heater 120, which may cause an elevation of the temperature circulating therein. When, for instance, valve 151 is open and, for instance, valve 152 is closed, such circulation and recirculation may occur. Then, having reached such sufficient temperature as may be required by those having ordinary skill in the art, components of microbiological liquid purification system 100 may cause, for instance, valve 151 to close and, for instance, valve 152 to open. Then, upon a demand for liquid at biologically pure liquid outlet 103, valve 152 may open, liquid held at such temperature may be then available to proceed through brazed plate heat exchanger 110, which may then cool the liquid therethrough via the processes described above, thereby providing near-ambient temperature liquid, which may now be microbiologically pure, to various potable water faucets, as described in relation to FIG. 6.

As a person having ordinary skill in the art may appreciate, other water treatment apparatuses may be included within microbiological liquid purification system 100 or may be present prior to or subsequent to the treatment of liquid as described herein. These include, but are not limited to those described above, such as filtration, carbon filtration, reverse osmosis, chemical treatment, desalination, coagulation, flocculation, sedimentation, other methods of disinfection, distillation, deionization, ionization, the like and/or combinations thereof. Those having ordinary skill in the art may further appreciate the benefits of providing microbiological liquid purification system 100, which does not necessarily require a safe water source, and may actually cause a very unsafe water source (such as a turbid water source) to become potable through the sterilization/microbiological inactivation processes as described herein. Those having ordinary skill in the art may further appreciate that certain aspects of microbiological liquid purification system 100 may be swapped, interchanged, duplicated, or otherwise reconfigured in certain embodiments to achieve certain results. By way of example and not limitation, in a potentially preferred alternate embodiment of microbiological liquid purification system 100, irradiation re-supply 122B may be connected at or in line with pre-irradiation supply 122A, and rather than meet high-efficiency liquid heater 120 at two inlets, may share an inlet of high-efficiency liquid heater 120. In these or other alternate embodiments, valve 151 and valve 152 may be placed as drawn therein FIG. 1, or may be present elsewhere as may be understood by those having ordinary skill in the art, such as proximate liquid source connection 102 and/or biologically pure liquid outlet 103. In such a configuration, liquid source connection 102 and biologically pure liquid outlet 103 may be opened and/or closed to activate microbiological liquid purification system 100 in an installation in which it is installed, and may further feature, for instance, a bypass and/or manifold. Valves 151, 152 may instead be present therebetween brazed plate heat exchanger 110 and high-efficiency liquid heater 120 and/or may be located proximate closed loop liquid heat maintenance pump 140. In some embodiments, no valve may exist between high-efficiency liquid heater 120 and liquid heat control chamber 130. Furthermore, those having ordinary skill in the art may further understand that multiple units of microbiological liquid purification system 100 may be installed in series in order to increase the sanitizing/sterilizing capacity of microbiological liquid purification system 100, based on a water demand. Additionally, though high-efficiency liquid heater 120 may be illustrated and described herein as featuring one or more irradiation sources, it may in fact feature many such that each irradiation source may act in coordination and/or be controlled by electronic controller 910 in order to provide sufficient heating capacity via high-efficiency liquid heater 120 during periods of greater demand.

As it may relate to FIG. 1, in one example possibly preferred embodiment, recirculation subassembly 140 may be minimally utilized and/or not utilized at all during normal operation of microbiological liquid purification system 100. In such an embodiment, sufficient heat may be provided by high-efficiency liquid heater 120 such that temperature at liquid heat control chamber 130 is sufficient to supply safe water at ambient temperatures on demand via brazed plate heat exchanger 110 and demand at biologically pure liquid outlet 103. It may be that the features and components, therefore only need to activate closed loop liquid heat maintenance pump 140 during periods of excess water consumption and/or demand at biologically pure liquid outlet 103, such that recirculation may be required, for example, only once in a 24-hour average.

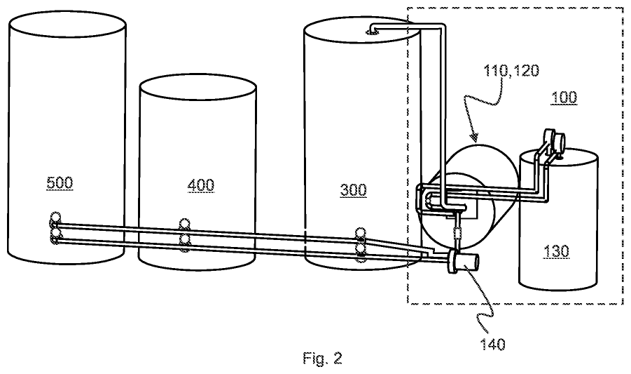

Turning to FIG. 2, illustrated therein is a perspective drawing of an exemplary embodiment of microbiological liquid purification system 100 of the disclosure, as it may be used in combination with tanks, which may be useful in a testing and/or storage embodiment. As may be understood by those having ordinary skill in the art, the perspective illustration of FIG. 2 may be simplified to highlight a basic configuration, which may or may not be applicable for the uses as described herein, such as residential, commercial, industrial, municipal, portable, the like and/or combinations thereof. Beginning at the left, hand side of FIG. 2, therein illustrated may be clean water tank 500, which may house, dispense, and/or make available for testing water having been treated by microbiological liquid purification system 100. Then, contaminated water tank 400 may reside near to sequestering/distribution tank 300, the former which may house, store, dispense, and/or make available for testing a water source prior to processing through microbiological liquid purification system 100. Sequestering/distribution tank 300 may be useful in this exemplary embodiment for various uses, such as storing water passed through microbiological liquid purification system 100, housing liquid heat control chamber 130 for later cooling/reprocessing of liquid, or various other uses as may be understood by those having ordinary skill in the art may understand or desire. Closed loop liquid heat maintenance pump 140 may distribute liquid through microbiological liquid purification system 100 as described above throughout microbiological liquid purification system 100, based upon the treatment protocol outlined above. Finally, brazed plate heat exchanger 110 and high-efficiency liquid heater 120 may be housed together within an enclosure, such as housing 101, may be housed separately, or may be housed along with other features of microbiological liquid purification system 100, as illustrated in FIG. 1. As illustrated therein FIG. 2, valves on influent tanks and prior to closed loop liquid heat maintenance pump 140 may be illustrated to demonstrate that in a testing environment of microbiological liquid purification system 100, inlet liquid may be controlled to clean water tank 500, contaminated water tank 400, and sequestering/distribution tank 300, such that microbiologically pure liquid therein clean water tank 500 and contamination of contaminated water tank 400 may be tested and/or verified.

Turning to FIG. 3, illustrated therein may be a cross-sectional drawing of an exemplary embodiment of high-efficiency liquid heater 120 of the disclosure. As may be understood by those having ordinary skill in the art, one or many of high-efficiency liquid heater 120 may be installed therein microbiological liquid purification system 100. Additionally, high-efficiency liquid heater 120 is not drawn to scale and may be taller or shorter, wider or narrower, or deeper or shallower than is illustrated therein FIG. 3. As noted above, high-efficiency liquid heater 120 may consist substantially of U.S. Pat. No. 5,371,830 entitled “HIGH-EFFICIENCY INFRARED ELECTRIC LIQUID-HEATER”, which has been fully incorporated and is summarized herein. As illustrated, liquid may enter high-efficiency liquid heater 120 through pre-irradiation supply 122 and exit high-efficiency liquid heater 120 through post-irradiation outlet 123. During its transit through high-efficiency liquid heater 120, water may be heated via exposure to, for instance, infrared light L. As shown in the cross-sectional perspective view of FIG. 3, infrared light L may include a tubular envelope having an exterior surface that establishes the inner boundary of the annular volume. A tungsten filament may be contained within the envelope and may be supported substantially on the longitudinal axis by spaced apart filament supports of conventional design. Each filament support may be fabricated from temperature resistant metal wire shaped in a spiral form with the filament carried in the centermost convolution of the filament support and with the outermost convolution of the filament support resiliently engaging the interior surface of the envelope. The filament may be typically formed as a continuous helix section intermediate straight end portions. In some embodiments of high-efficiency liquid heater 120, the helical formation has a diameter of about 0.100 inches with the filament wire having a 0.036 inch diameter. When electrical current flows through the filament of infrared light L, its surface temperature may be in the range of 4600° F. The opposite ends of the envelope may be thermally collapsed around and about the straight end portions of infrared light L to form a sealed volume, as is conventional in the art. The end portions of infrared light L may be connected with a source of electrical energy, such as power source 900 or transformer 901. Upon entry of high-efficiency liquid heater 120 at pre-irradiation supply 122, liquid may be at relatively low temperatures, and raised as the pass over infrared light L of high-efficiency liquid heater 120, and hence be raised to high temperatures at post-irradiation outlet 123, where the liquid may exit high-efficiency liquid heater 120 and be further processed as herein described.

Turning to FIG. 4, illustrated therein is an exterior plan view drawing of an exemplary brazed plate heat exchanger 110 of the disclosure. Generally, liquid heat control chamber 130 may be provided for transferring heat between a first fluid and a second fluid, with the second fluid being pressurized to a relatively high pressure or, preferably, heated to a relatively high temperature. The heat exchanger may generally include plate pairs, with each pair defining a plurality of flow channels for the first and second fluids. Each of the flow channels may have a hydraulic diameter less than 1 mm such that they have a high plate surface-area to volume ratio and thus are extremely capable of transferring heat from the first fluid to the second fluid, but also, importantly, cooling a heated water which has been processed by microbiological liquid purification system 100 using its ambient temperature water source down to an ambient temperature while simultaneously raising the incoming water flow temperature such that efficiency of microbiological liquid purification system 100 may be maintained while the incoming stream is heated. As illustrated herein, brazed plate heat exchanger 110 may include at least 4 openings 112, 113, 114, and 115 for receiving a liquid and dispensing it. While those having ordinary skill in the art may understand various preferable and/or ideal configurations may exist for which of openings 112, 113, 114, and 115 as to which may be inlets and which may be outlets, the disclosure is not so limited to any configuration. Proper connections must be determined by those having ordinary skill in the art in order to supply the first sealed compartment having the series of brazed plate compartments such that an inlet/outlet pair connects either of liquid source connection 102 and pre-irradiation supply 122A, and another inlet/outlet pair receives liquid from the open valve 152 and exits brazed plate heat exchanger 110 through to biologically pure liquid outlet 103.

Turning to FIG. 5, illustrated therein may be a cross-sectional elevation drawing of an exemplary embodiment of liquid heat control chamber 130. After heating a liquid via high-efficiency liquid heater 120, the liquid may enter liquid heat control chamber 130 through liquid heat control chamber inlet 132, be transmitted through liquid heat control chamber coils 131, which are surrounded by liquid heat control chamber insulation 139, and exit liquid heat control chamber 130 through liquid heat control chamber outlet 133. By increasing the temperature of fluid entering microbiological liquid purification system 100 via high-efficiency liquid heater 120, and holding such temperature using liquid heat control chamber 130 while maintaining flow of the fluid due to the coil arrangement therein, liquid temperatures may be maintained at high levels for sufficient periods to sterilize and/or neutralize any microorganisms therein. Liquid heat control chamber 130 and liquid heat control chamber coils 131 thereof may have an ID of 0.5-2.0 inches. Liquid heat control chamber 130 and liquid heat control chamber coils 131 thereof may have an overall (uncoiled) length of 100-400 feet, or may be substantially smaller in portable versions of microbiological liquid purification system 100. Liquid heat control chamber 130 and liquid heat control chamber coils 131 thereof may have a total number of turns, when coiled, of 10-200, with various overall coil radii, depending on configuration, but 6 to 48 inches in potentially preferable configurations. Depending on flow rate, quality of liquid heat control chamber insulation 139, and material of liquid heat control chamber coils 131, temperature may be substantially maintained from liquid heat control chamber inlet 132 to liquid heat control chamber outlet 133. Upon a confirmation of approximately 100° C. temperatures at liquid heat control chamber outlet 133, recirculation from high-efficiency liquid heater 120 through liquid heat control chamber 130 may be suspended and liquid may exit microbiological liquid purification system 100 via the steps outlined above, and be cooled in the process. Electronic controller 910 in combination with various sensors, thermometers, computing devices, closed loop liquid heat maintenance pump 140, the like and/or combinations thereof may control such processes.

Turing to FIG. 6, illustrated therein may be a cross-sectional drawing of one exemplary implementation of microbiological liquid purification system 100: a family home or home H. As illustrated therein, water may enter home H via liquid source connection 102. Such liquid source connection 102 may be supplied by a known contaminated water source having microorganisms therein. Upon processing, as described herein, microbiological liquid purification system 100 may sterilize and/or otherwise neutralize these microorganisms through heat treatment over a period of time through microbiological liquid purification system 100 and may exit microbiological liquid purification system 100 through biologically pure liquid outlet 103. Then, through either newly installed or existing plumbing within home H, water may be supplied to bathroom sink S, bath B, and kitchen K, such that otherwise unsafe water may be made potable reliably at a rate of, for instance, 6 GPM.

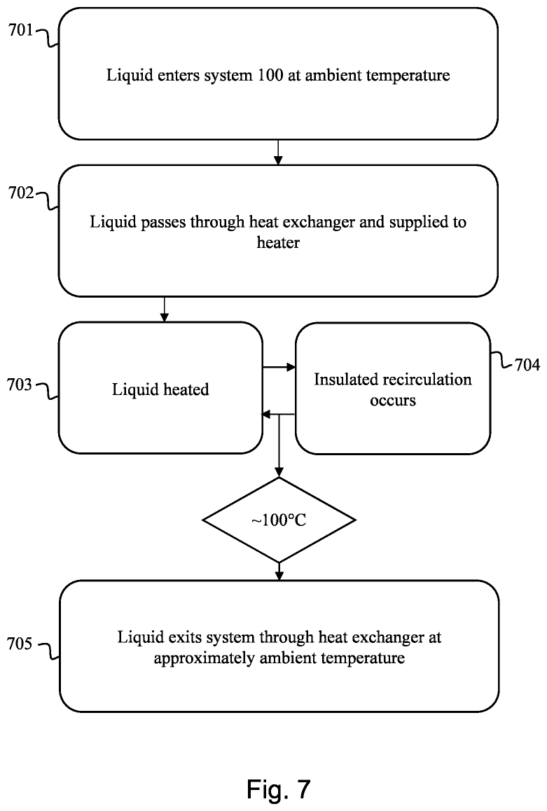

Turning now to FIG. 7, illustrated therein is a flowchart of a proposed method of installation and use of microbiological liquid purification system 100. At step 701, water may enter microbiological liquid purification system 100 via liquid source connection 102 at ambient temperatures. It may be passed through brazed plate heat exchanger 110 and be supplied to high-efficiency liquid heater 120 in order to raise the temperature at step 702. Recirculation may be allowed to occur into liquid heat control chamber 130 via closed loop liquid heat maintenance pump 140 and back through high-efficiency liquid heater 120 at recirculation step 703 until a sufficient temperature has been achieved and valve 152 may open to allow fluid to pass back through brazed plate heat exchanger 110, cooling the liquid while simultaneously heating new liquid entering microbiological liquid purification system 100 at step 704. Finally, liquid may exit microbiological liquid purification system 100 via biologically pure liquid outlet 103 and be supplied to a home, residence, office, factory, other building, encampment, the like and/or combinations thereof.

During an experimental installation of microbiological liquid purification system 100 according to, for example FIG. 2 using the methods of FIG. 7, performance of exemplary embodiments of microbiological liquid purification system 100 were conducted to understand their capabilities in meeting microbiological purity standards, as set forth above. A general test water and a worst-case test water were provided for intake into an exemplary embodiment of liquid source connection 102. The general test water had no chlorine residue, a 6.5-8.5 pH, 0.1-5.0 mg/L total organic carbon, a 0.1-5.0 NTU turbidity, a 15-25° C. temperature range, and 50-500 mg/L total dissolved solids. A worst-case water had no chlorine residue, a 8.8-9.2 pH, greater than 10 mg/L total organic carbon, a greater than 30 NTU turbidity, a 3-5° C. temperature range, and 1,500-15,000 mg/L total dissolved solids. Testing of each water source showed presence of Cryptosporidium parvum oocysts, Klebsiella terrigena, Poliovirus, and Rotavirus. The log inactivation of C. parvum oocysts by an exemplary embodiment of microbiological liquid purification system 100 in the laboratory ranged from 3.44 to >4.24 for the general test water, and from 3.857 to >4.05 for the worst-case test water. This represented at least a 99.6% reduction in all experimental testing of microbiological liquid purification system 100, with some tests yielding more than a 99.99% reduction. Similar or better results were obtained for the reduction of K. terrigena, Poliovirus, and Rotavirus, which saw over 99.99% reduction across each water tested.

It is contemplated herein that the components and/or machines of the disclosure include variations in size, shape, construction, manufacture, components, power source, heat source, liquid source, liquid type, assembly, the like and/or combinations thereof. The devices and systems of the disclosure may be powered and controlled using external systems, or may be powered and/or controlled internally within a particular device or the overall system through use of any known method of powering and controlling any device or system of the disclosure. While specific dimensions, shapes, angles, reservoirs, containers, apparatuses, sensors, machines, components, sub-components, pumps, heat exchangers, motors, bearings, the like and/or combinations thereof may be specifically described herein, the disclosure is not so limited. Microbiological liquid purification system 100 of the disclosure may be installed permanently at a given water supply, may be portable, or may be some combination of portable and permanent. Furthermore, microbiological liquid purification system 100 may be used as a primary, secondary, tertiary, etc. process for the purification of water, it may be used as a sole process for the purification of water, or may be otherwise incorporated as a single process within a multi-step water purification procedure. While the machine may be used purify liquids, namely water, as disclosed herein, other uses of the machines, systems and processes as described herein may be understood by those skilled in the art to apply to the purification of other substances, including but not limited to the purification and/or distillation of alcoholic beverages and/or spirits, petrochemical compositions, oils, solvents, other liquids (or liquids having dissolved solutes and/or emulsified solids, such as pre-carbonated soft drinks), the like and/or combinations thereof and the disclosure is not so limited to include only the disclosed uses with respect to the liquids herein described. Water, as herein described, may be any liquid having some detectable percentage of oxygen hydride (water) or any other matter in its liquid phase. While various components and features of the disclosed microbiological liquid purification system 100 are described with various levels of specificity with regard to their composition, features, and capabilities, the disclosure is not so limited, and one skilled in the art of water and/or liquid purification may make reasonable substitutions within the bounds of the disclosure.

The foregoing description and drawings comprise illustrative embodiments of the present disclosure. Having thus described exemplary embodiments of microbiological liquid purification system 100 and its method of use, it should be noted by those ordinarily skilled in the art that the within disclosures are exemplary only, and that various other alternatives, adaptations, and modifications of the microbiological liquid purification system may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

What is claimed is:

1. A system for a microbial purification of a fluid, the system comprising:
a brazed plate heat exchanger for receiving the fluid from an ambient temperature fluid source, said brazed plate heat exchanger having an inlet for receiving the fluid, a first outlet connection, a second outlet connection, and an inlet connection for receiving a heated fluid;
a flow channel configured to expose the fluid to an infrared irradiation, said flow channel receives the fluid from said first outlet connection, said flow channel further comprising a heated fluid outlet;
an infrared radiation source configured to heat the fluid through exposure to said infrared irradiation;
an insulated circulation chamber having a plurality of coils for a passage of the fluid therethrough, said insulated circulation chamber receives the fluid from said flow channel;
a recirculation pump for receiving the fluid from said insulated circulation chamber and directing the fluid to each of said flow channel in a first valve configuration and said inlet connection in a second valve configuration; and
a sensor capable of measuring a temperature of the fluid proximate said recirculation pump;
wherein upon said sensor detecting said temperature above a threshold temperature, said recirculation pump redirects the fluid to said inlet connection of said brazed plate heat exchanger.

2. The system of claim 1, wherein said insulated circulation chamber further comprises an insulating material substantially surrounding said plurality of coils.

3. The system of claim 2, wherein said plurality of coils is a continuous, sealed pipe having an internal diameter of at least 0.5 inches.

4. The system of claim 3, wherein said plurality of coils have a coil radius of at least 6 inches.

5. The system of claim 4, wherein said plurality of coils are at least 10 coils.

6. The system of claim 1, said threshold temperature is 100° C.

7. The system of claim 1, further comprising a power source connected to said infrared radiation source, a low-voltage transformer connected to said recirculation pump, and an electronic controller connected to said sensor and said recirculating pump.

8. The system of claim 7, further comprising a housing, said housing contains said brazed heat plate exchanger, said flow channel and said infrared radiation source, said insulated circulation chamber, said recirculation pump and said sensor.

9. The system of claim 1, wherein said brazed plate heat exchanger cools the fluid using said ambient temperature fluid source.

10. The system of claim 1, wherein the fluid when entering said brazed plate heat exchanger is a contaminated or turbid water supply.

11. The system of claim 10, wherein the fluid when exiting said brazed plate heat exchanger is a microbiologically pure water.

12. A method for a purification of a fluid, the method comprising the steps of:
passing the fluid through a brazed plate heat exchanger from an ambient temperature fluid source, said brazed plate heat exchanger having an inlet for receiving the fluid, a first outlet connection, a second outlet connection, and an inlet connection for receiving a heated fluid;
receiving the fluid from said first outlet connection and passing the fluid through a flow channel configured to expose the fluid to an infrared irradiation from an infrared radiation source, said flow channel further comprising a heated fluid outlet;
receiving the fluid from said heated fluid outlet passing the fluid through an insulated circulation chamber having a plurality of coils;
receiving the fluid at a recirculation pump;
directing the fluid to said flow channel via said recirculation pump;
monitoring a temperature of said fluid via a sensor installed proximate said recirculation pump; and
upon said sensor detecting said temperature above a threshold temperature, redirecting the fluid to said brazed plate heat exchanger.

13. The method of claim 12, further comprising cooling the fluid using said ambient temperature fluid source within the brazed plate heat exchanger.

14. The method of claim 13, further comprising controlling a flow rate of the recirculation pump based upon a water demand.

15. The method of claim 14, supplying the fluid to a home plumbing system via said second outlet connection of said brazed plate heat exchanger.

16. The method of claim 12, wherein said insulated circulation chamber further comprises an insulating material substantially surrounding said plurality of coils.

17. The method of claim 16, wherein said plurality of coils is a continuous, sealed pipe having an internal diameter of at least 0.5 inches.

18. The method of claim 17, wherein said plurality of coils is a continuous, sealed pipe having an internal diameter of at least 0.5 inches.

19. The method of claim 18, wherein said plurality of coils are at least 10 coils.

20. The method of claim 12, said threshold temperature is 100° C.
